(19) United States
(12) Patent Application Publication
(10) Pub. No.: US 2005/0232392 A1
(43) Pub. Date: Oct. 20, 2005

(54) Nanostructure field emission x-ray analysis

(76) Inventors: Keith Bradley, New York, NY (US); Jeff Wyatt, Berkeley, CA (US)

Correspondence Address: Keith Bradley, 342 West 89th St., #4B, New York, NY, 10024, US

(21) Appl. No.: 11/064,810

(22) Filed: Feb. 24, 2005

Related U.S. Application Data
(60) Provisional application No. 60/548,384, filed on Feb. 25, 2004.

(51) Int. Cl. G01T 1/36; G01N 23/223

(52) U.S. Cl. 378/45

(57) ABSTRACT

The present invention relates to the use of nanostructure-based field emission x-ray sources in compact, portable x-ray fluorescence spectrometers for elemental analysis in the field. Devices comprising one or more x-ray sources and one or more x-ray detectors are disclosed. Methods to use multiple sources are disclosed.

This application claims the benefit of U.S. Provisional Patent Application No. 60/548,384, filed Feb. 25, 2004.

### FIELD OF THE INVENTION

The present invention relates to the use of nanostructure-based field emission x-ray sources in compact, portable x-ray fluorescence spectrometers for elemental analysis in the field. The invention particularly relates to the application of these devices for the characterization of boreholes.

### SUMMARY OF RELATED ART

Oil and gas, as well as groundwater, come from accumulations in the pore spaces of reservoir rocks (usually sandstone, limestone, or dolomites) and are removed via wells. Because the amount of oil and gas in these pore spaces is dependent upon the rock's characteristics, the oil and gas industry often needs to determine the characteristics of underground formations to predict the commercial viability of a new or existing well. Information on certain properties of an underground formation, such as type of rock, porosity, hydrocarbon content, and density is important to determine how the resource can be exploited and maintained. These properties are particularly important in the evaluation of oil and gas reservoirs.

In underground drilling applications, a bore hole is drilled through a formation deep in the earth. Such bore holes are drilled or formed by a drill bit connected to end of a series of sections of drill pipe, so as to form an assembly commonly referred to as a “drill string.” The drill string extends from the surface to the bottom of the bore hole. As the drill bit rotates, it advances into the earth, thereby forming the bore hole. The distal or bottom end of the drill string, which includes the drill bit, is referred to as a “down hole assembly.” In addition to the drill bit, the down holed assembly often includes specialized modules or tools within the drill string that make up the electrical system for the drill string. Such modules often include sensing modules, usually referred to as well logging tools. In many applications, the sensing modules provide the drill string operator with information regarding the formation as it is being drilled through. Alternatively, well logging tools that include sensors can be lowered into the bore hole after drilling.

One well logging technology is dedicated to elemental analysis of the borehole as the sensing modules penetrate through the formation. In this technology, known as gamma-ray induced X-ray fluorescence, a sealed radioactive source is lowered on the drill string. Americium-241 and cesium-137 are the radioactive materials most frequently used for this purpose. These materials emit gamma rays, which are absorbed by the rock of the formation. Atoms in the rock which have absorbed gamma rays are excited, and they relax by emitting X-rays. The emitted radiation is characteristic of the atoms involved. Detectors located near the radioactive sources receive this radiation. The information collected by these detectors can be used to identify the elemental composition of the borehole. Traditionally, the radioactive sources and detectors are lowered into a well on a wireline, which ranges in length from several hundred feet to greater than 30,000 feet. Signals from the detectors are transmitted to the surface through the wireline and plotted on a chart as the logging tool is lowered into or raised from the well. The use of such a device is disclosed in U.S. Pat. No. 4,510,573, by Boyce et al., and in U.S. Pat. No. 5,144,245, by Wisler et al. Another type of sensor, involving magnetic resonance imaging, is disclosed in U.S. Pat. No. 5,280,243, by Miller et al. Alternative technologies that could be usefully employed in well logging and down hole fluids analysis are impractical largely because of geometric or operational constraints. Examples of these constraints include the diameter of the hole, the temperature of operation, limited availability of power, and rugged conditions.

X-ray fluorescence spectrometry is an example of a technology that is limited by these constraints. It is necessary to use gamma-ray induced X-ray fluorescence, as described above, because gamma ray sources match the constraints. Gamma ray sources, however, are expensive and dangerous in practice. A preferable method would be X-ray induced X-ray fluorescence. This technique is commonly used in laboratory environments, with benchtop instruments providing bulky X-ray sources with which to irradiate samples. However, conventional X-ray sources do not fit within the constraints required for well logging.

X-ray fluorescence is used in a variety of other applications. For example, the mining industry uses this technique to search for metal ore deposits. Coring drills remove long cores of solid earth. These cores are brought to the surface, where they are examined for the presence of elements such as gold, platinum, copper, titanium, and other transition metals. Gamma-ray induced x-ray fluorescence spectrometers are used to analyze the elemental composition of these cores and identify valuable elements. It would be desirable to use such spectrometers in mines as well as on the surface. However, they rely on radioactive materials as sources for the gamma rays, and safety considerations preclude the use of radioactive materials in mines.

### SUMMARY OF THE INVENTION

As has been described, a portable x-ray fluorescence spectrometer would be useful for a variety of applications. The invention provides such a spectrometer, together with methods for its use. This specification focuses on two particular applications, in borehole characterization and mining operations, but other applications are intended to be included. These include, but are not restricted to, metallurgical alloy identification, field analysis of soil samples, and groundwater analysis.

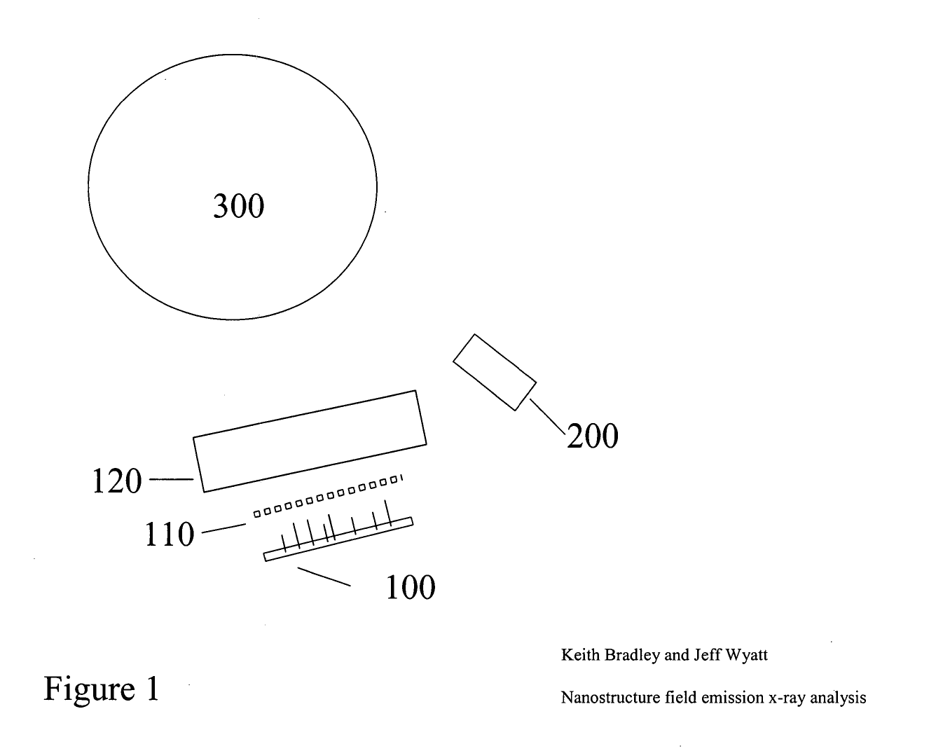

The potential applications of X-ray fluorescence spectrometry are wide-ranging because it is such a versatile method for elemental analysis. Reflecting this importance, X-ray fluorescence spectrometers commonly used as laboratory instruments (FIG. 1a) which can produce a complete analysis of elements between sodium and uranium, down to concentrations of 1%. Such instruments are bulky and expensive, due to the size and complexity of conventional x-ray detectors and sources. Recently, miniaturized detectors have been developed, enabling the construction of somewhat smaller spectrometers. The invention combines an x-ray source which can be made compact and robust with a miniature x-ray detector to provide small instruments for X-ray induced X-ray fluorescence spectrometry. These instruments can be used for a variety of applications, particularly including elemental analysis in deep boreholes.

An x-ray fluorescence spectrometer induces a sample to fluoresce x-rays which are then detected and analyzed. Therefore, the instrument has two main components, the source and the detector. Detectors typically consist of crystals of semiconducting silicon or germanium. They function somewhat like single-pixel CCD cameras. Electromagnetic radiation (photons) is absorbed by the crystal, exciting electrons in the semiconductor. These electrons are counted by electronics attached to the crystal. An x-ray photon generates thousands of electrons, with the precise number depending on its energy. Thus, by counting the electrons, the instrument can determine the energy of each incoming x-ray photon. Important operational constraints include the size and power requirements of the attached electronics, in particular the requirement that the crystal be biased to ˜1 kV; the size of the crystal itself, with larger sizes providing greater sensitivity; and the bulk of the cooling system required to keep the crystal below room temperature for reduced noise. In typical instruments, such as the Niton XLi 800, the crystal is less than ½″, and the entire package is less than 3 lbs in weight.

The source used in x-ray spectrometers can be anything that induces x-ray fluorescence. This includes energetic electrons and energetic photons such as x-rays and gamma rays. For example, in a common laboratory application, an x-ray spectrometer may be mounted in a scanning electron microscope. As the beam scans over a sample, it induces x-rays. The analysis of these x-rays produces a map of the elemental composition of the sample. The integrated instrument, called an electron microprobe analyzer, is an important instrument for geological research. This approach is not practical for most applications, because electrons can only travel in vacuum. In laboratory x-ray fluorescence spectrometers, the fluorescence is usually induced by x-rays. X-rays penetrate through air and liquids, so that they can induce fluorescence from samples in ordinary environments. However, x-ray sources are large and power-hungry, so that they are used mainly in permanently installed instruments.

For portable instruments, the most common source is a sample of radioactive material (most commonly americium-241) which emits gamma rays. Although these sources are small and require no power, they suffer major disadvantages. First, being radioactive, they are dangerous. The radioactivity can not be turned off, but can only be shuttered when the device is not in use. The brightness of the source is limited by safety considerations. And the use of such a source brings the costs associated with handling radioactive material. Second, these sources can't induce fluorescence over a broad range of x-ray energies. Each radioactive isotope induces fluorescence from a certain set of elements. If a material contains one of those elements, it will be registered; other elements will be ignored. Because of these disadvantages, portable instruments have been restricted to analysis of materials about which a user already has information, such as distinguishing one alloy of steel from another.

The X-ray source provided in the invention uses electrons generated by field emission. Such a source is described in U.S. Pat. No. 6,553,096, by Zhou et al., hereby incorporated by reference. In brief, the structure includes a cathode comprising nanostructures. The utility of nanostructures is that they provide long-lived, sharp tips for electron field emission. Many types of nanostructures can be used for this purpose, including, but not limited to, nanowires, nanorods, and nanotubes. Preferably the nanostructures are carbon nanotubes. The nanostructures may be mixed with a binder material to form a composite, as described in U.S. Pat. No. 6,057,637, by Zettl et al., hereby incorporated by reference. Field emission from the cathode is induced by the application of an electric potential between the cathode and an emission electrode. When the cathode is maintained at a negative potential, the strong electric field at the tips of the nanostructures causes emission of electrons from the nanostructures. An anode target is provided, and the position of the target is arranged so that the emitted electrons bombard the target. The target is made from a material which emits x-rays in the range of interest. Preferably the material is a metal, and more preferably the material is iron, copper or manganese. In order to excite x-rays from the target, the electrons must be accelerated to a high voltage. Consequently an accelerating voltage is applied between the cathode and an accelerating electrode. This energy of the electrons must be at least as large as the energy of the x-rays to be excited from the target. Preferably the accelerating voltage is at least 1.5 kV, and more preferably the accelerating voltage is at least 3 kV.

In some embodiments of the invention, the emission electrode is identical with the accelerating electrode and anode target. In other embodiments, the emission electrode is distinct from the accelerating electrode, which is identical with the anode target. In still other embodiments, the emission electrode is distinct from the accelerating electrode, which is distinct from the anode target. In some embodiments, the accelerating electrode is in the form of a grid.

The field emission x-ray source is combined with an energy-dispersive x-ray detector to form a device for x-ray fluorescence spectrometry. Energy-dispersive x-ray detectors are distinct from other x-ray detectors. Conventional x-ray detectors, such as photographic film or charge-coupled device cameras, can be used to count the number of x-rays received in a period of time. In comparison, energy-dispersive x-ray detectors can additionally measure the energy of each individual x-ray that is received. An example of an energy-dispersive x-ray detector is a silicon chip that is connected to signal processing circuitry. An individual x-ray that is absorbed by the detector produces a number of charge carriers in the chip. These charge carriers are measured by the signal processing circuitry. The number of carriers is related to the energy of the x-ray, and thus the energy of the x-ray can be measured.

To enable the fluorescence of a sample to be measured, the field emission x-ray source and the energy-dispersive x-ray detector are positioned so that both are aimed at the sample. The sample is irradiated by x-rays emitted by the source. As a result, the sample emits fluoresced x-rays, which irradiate the detector. To avoid contamination of the results, the detector must be positioned so that x-rays from the source do not irradiate the detector.

The field emission x-ray source differs from conventional x-ray sources in numerous advantageous ways. First, it is not hot, as are conventional x-ray sources. Consequently, the source can be made small. This enables the inventive spectrometry device to be more compact and lighter than other spectrometers. Second, the field emission source is much more efficient than conventional sources. Here efficiency refers to the rate of x-ray production divided by the power provided to the source. A more efficient source can provide more x-rays to irradiate a sample, thus increasing signal-to-noise ratio. In addition, a more efficient source requires less power. When the inventive device is configured as a portable spectrometer, it requires relatively low battery power. When the inventive device is configured as a remote spectrometer lowered into a borehole, it requires a relatively light power cable. Both of these advantages, the size and the power requirements, make the inventive device more robust than spectrometers using conventional x-ray sources.

An additional advantage of field emission x-ray sources is that they can be switched on and off rapidly. One use of this property is described in U.S. Pat. App. No. 2002/0094064, by Zhou et al., which is hereby incorporated by reference. The present invention provides methods for x-ray spectrometry in which this property is used. It will be appreciated by those skilled in the art that the inventive device can also be used according to the methods already known.

In a first embodiment, the power requirements can be reduced even farther by operating the x-ray source only part of the time. In portable applications, the x-ray source within the inventive device only needs to be fully powered at the moment when a sample is to be irradiated. When the device is being moved from one sample to the next, the x-ray source can be switched off. In well logging, it will sometimes be desirable to log only a fraction of the depth traversed by the device as it is lowered into the well. For example, only one foot in ten may be analyzed, by turning off the x-ray source for nine feet out of ten. Alternatively, it will sometimes be desirable to analyze a borehole only in specific circumstances. For example, an additional sensor may detect the presence of water within the borehole. The x-ray source can be switched off until water is detected.

In a second embodiment, two field emission x-ray sources are incorporated within a single spectrometer, and the two sources are used to discriminate fluorescence from the background. Thus, this device and its associated method enable more precise elemental analysis. The largest component of the background is non-fluoresced x-rays, most commonly from bremsstrahlung. A second component that is sometimes present is secondary fluoresced x-rays, from other elements, with energies that overlap the energy of the primary fluoresced x-rays of an element of interest. These two types of background should be discriminated from the primary fluoresced x-rays from elements of interest. These are three types of x-rays which are emitted from a sample which is irradiated by x-rays. The rate at which they are emitted depends on the energy of the incident x-rays. The inventive method relies on the fact that these three different types have three different mathematical dependences. Each element's x-ray fluorescence spectrum depends on the energy of the incident x-rays with a different mathematical function. In addition, bremsstrahlung radiation depends on the energy of the incident x-rays with another function.

In this embodiment, at least two field emission x-ray sources are incorporated within a single spectrometer, the at least two different sources constructed to emit x-rays of different energies. In one embodiment, such a construction uses different materials for the anode targets in the at least two sources. In another embodiment, the targets use similar materials, but the accelerating voltage is different in the at least two sources. The incorporation of two sources in one spectrometer is made possible by the small size of field emission x-ray sources. The at least two x-ray sources are switched on and off alternately. The signal from the energy-dispersive x-ray detector is recorded first while a first x-ray source irradiates the sample, and second while a second x-ray source irradiates the sample. Thus, at least two different fluorescence spectra are recorded, gathered with different energies of irradiating x-ray. These spectra are compared to distinguish bremsstrahlung and the spectra from particular elements. In one embodiment, the first energy is chosen to be below the energy required to induce fluorescence from the sample.

An exemplary use of this method is the sensitive detection of gold in rock. In this example, the first x-ray source is chosen to comprise a niobium target, and the second x-ray source is chosen to comprise a zirconium target. The first source uses an accelerating voltage of 2.20 volts, so that the energy of its emitted x-rays is that of niobium Lα x-rays, 2.166 kV. The second source uses an accelerating voltage of 2.05 kV, so that the energy of its emitted x-rays is that of zirconium Kα x-rays, 2.042 kV. These energies are chosen specifically because the first energy barely insufficient to excite Mα x-rays from gold, with an energy of 2.122 kV, while the second energy is barely sufficient to excite such x-rays. At the same time, the difference between the two energies is not very great. The various background processes that contribute extraneous x-rays will contribute approximately the same numbers of x-rays at these two slightly different energies. However, the x-rays of interest, those which are characteristic x-rays from any gold in the sample, are contributed only during irradiation by the second source. Thus, the two sources are used alternately. First the first source is switched on, and a first x-ray spectrum is recorded. Then, the first source is rapidly switched off, and the second source is switched on. A second x-ray spectrum is then recorded. The difference between these two spectra at the energy of 2.122 kV is a precise, sensitive indicator of the presence of gold in a sample. It can readily be appreciated that this example relates to the sensitive detection of any particular element, for example titanium, chromium, manganese, iron, cobalt, nickel, copper, zinc, molybdenum, palladium, silver, tin, tantalum, tungsten, platinum, gold, or mercury. The first and second source need only be chosen to correspond to the element of interest.

A second example of the method relates to the use of x-ray fluorescence spectrometers to measure the density of a fluid. As an illustration, we describe the measurement of the density of carbon atoms in a hydrocarbon fluid, for purposes such as distinguishing oil and gas. First, we describe an inventive method for measuring the density of fluids using x-ray fluorescence. A first source is placed next to the fluid, such that the x-rays emitted from the source travel in a direction through the fluid. In one embodiment, a detector is placed next to the fluid, such the x-rays from the first source travel through the fluid towards the detector. Those x-rays which are not absorbed by the fluid are received by the detector, which measures the intensity of x-rays received. The use of field-emission x-ray sources for this purpose enables the insertion of such devices in small spaces such as bore holes in rock. In another embodiment, a detector is placed next to the fluid, such that the x-rays fluoresced by the fluid travel in a direction to the detector. In one embodiment, the detector is located such that this direction is perpendicular to the direction traveled by the x-rays from the first source. In another embodiment, the detector is located such that this direction is parallel to the direction traveled by the x-rays from the first source. X-rays from the first source are absorbed by the carbon atoms in the fluid. Consequent to the absorption of x-rays, the carbon atoms fluoresce characteristic x-rays with an energy of 282 volts. The detector is located at a certain distance from the source, said distance labeled x. The number of characteristic x-rays received at the detector depends on the number of x-rays fluoresced in its immediate vicinity, since x-rays of 282 volts have a very short range in hydrocarbon fluids. The number of x-rays fluoresced from the region of fluid that is in the vicinity of the detector depends on the number of x-rays from the source that are absorbed in the region of fluid. This number is the product of the number of x-rays from the source that arrive in the region of fluid, the density of carbon atoms in the region of fluid, and the probability that a carbon atom absorbs an x-ray. This relationship can be described by an equation as I_{fluoresced}(x)=I_{incident}(x)*ρ*μ, where I is the intensity of x-rays at a distance x from the source, ρ is the density of carbon atoms, and μ is the probability of absorption. The number of x-rays that arrive in the region of fluid can be calculated by the equation I_{fluoresced}(x)=I_{incident}(0)*exp(−ρμx). Thus, the number of x-rays received by the detector is related to I_{fluoresced}(x)=I_{incident}(0)*ρ*μ*exp(−ρμx). It is sensitive to the density of carbon atoms in two ways. First, a higher density of carbon atoms causes more fluorescence to happen in the region of fluid, for a fixed number of incident x-rays. Second, a higher density of carbon atoms causes fewer x-rays to reach the region of fluid, because more of the x-rays from the source are absorbed by carbon atoms between the source and the region of fluid. Thus, the density of carbon atoms can be known by measuring the number of fluoresced x-rays received at the detector. It is readily appreciated that this method is applicable to many materials besides hydrocarbon fluid. In particular, it is not necessary that the fluid should contain only one type of absorptive atom. Since the method operates by measuring characteristic fluoresced x-rays, it is sensitive to the density of the element of interest, as opposed to the density of the overall fluid. For example, this method can be used to distinguish methane hydrates from organic silt in water.

However, the method can be significantly improved by the addition of a second source. To see how, note that for a given density of carbon and a given x-ray source energy, there is a certain position at which the detector can be located at which it would receive the most x-rays. Conversely, for a given location and a given x-ray source energy, there is a certain density of carbon for which the detector would receive the most x-rays. For greater densities and for lower densities, the detector would receive fewer x-rays. As a result, a measurement of the number of fluoresced x-rays would be ambiguous, because it would be unclear whether the carbon density was below or above the maximal density. To solve this problem, a second source can be added, oriented so that its emitted x-rays travel in a direction perpendicular to the x-rays from the first source and perpendicular to the x-rays received by the detector. The first source is turned on and the characteristic x-rays are measured. Then the first source is rapidly switched off and the second source is switched on. Then the characteristic x-rays are measured again. As an example, the energies of the first source and second source are chosen to be 5 kV and 10 kV, respectively. As a result, when the characteristic x-rays from the first source do not unambiguously measure the carbon density, the characteristic x-rays from the second source provide sufficient information to determine the density precisely.

It is appreciated that these two examples do not restrict the application of this device and this method.

### DESCRIPTION OF THE DRAWINGS

FIG. 1: Schematic of an x-ray spectrometer.
1-100: A nanostructure anode from which electrons are emitted.
1-110: An accelerating grid.
1-120: A target, which absorbs electrons and emits x-rays.
1-200: An x-ray detector.
1-300: A sample, which is irradiated by x-rays from the target and fluoresces x-rays which are detected by the detector.

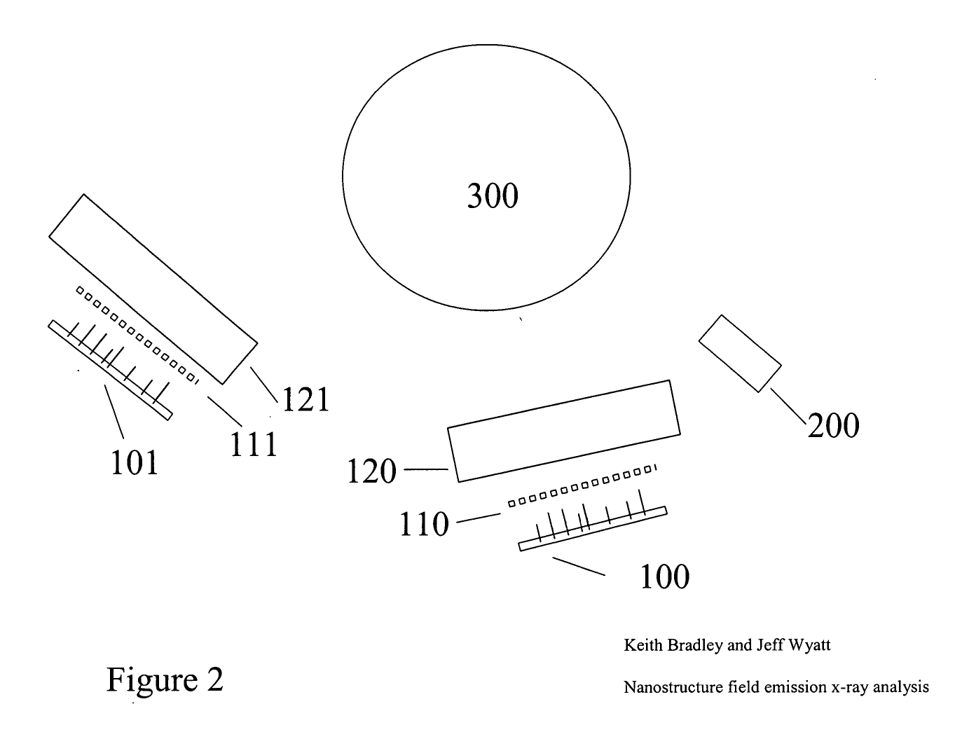

FIG. 2: Schematic of a two-source x-ray spectrometer.
2-100: A nanostructure anode from which electrons are emitted.
2-110: An accelerating grid.
2-120: A target, which absorbs electrons and emits x-rays.
2-101: A second nanostructure anode from which electrons are emitted.
2-111: A second accelerating grid.
2-121: A second target, which absorbs electrons and emits x-rays.
2-200: An x-ray detector.
2-300: A sample, which is irradiated by x-rays from the target and fluoresces x-rays which are detected by the detector.

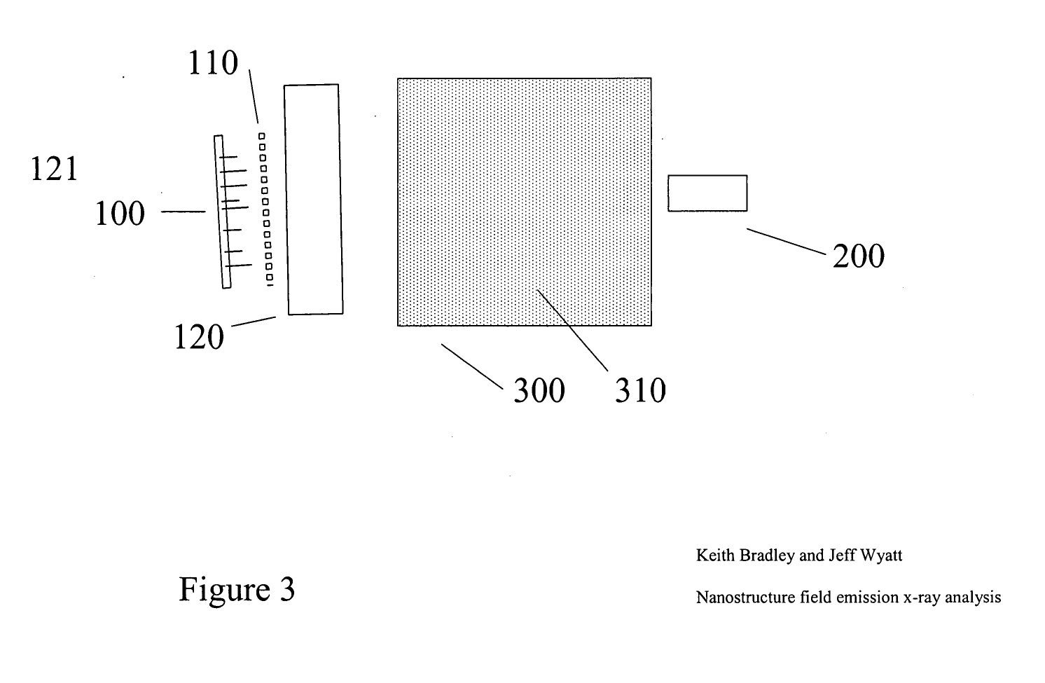

FIG. 3: Schematic of a device for measuring the density of fluids.
3-100: A nanostructure anode from which electrons are emitted.
3-110: An accelerating grid.
3-120: A target, which absorbs electrons and emits x-rays.
3-200: An x-ray detector.
3-300: A chamber containing fluid.
3-310: Fluid for density analysis.

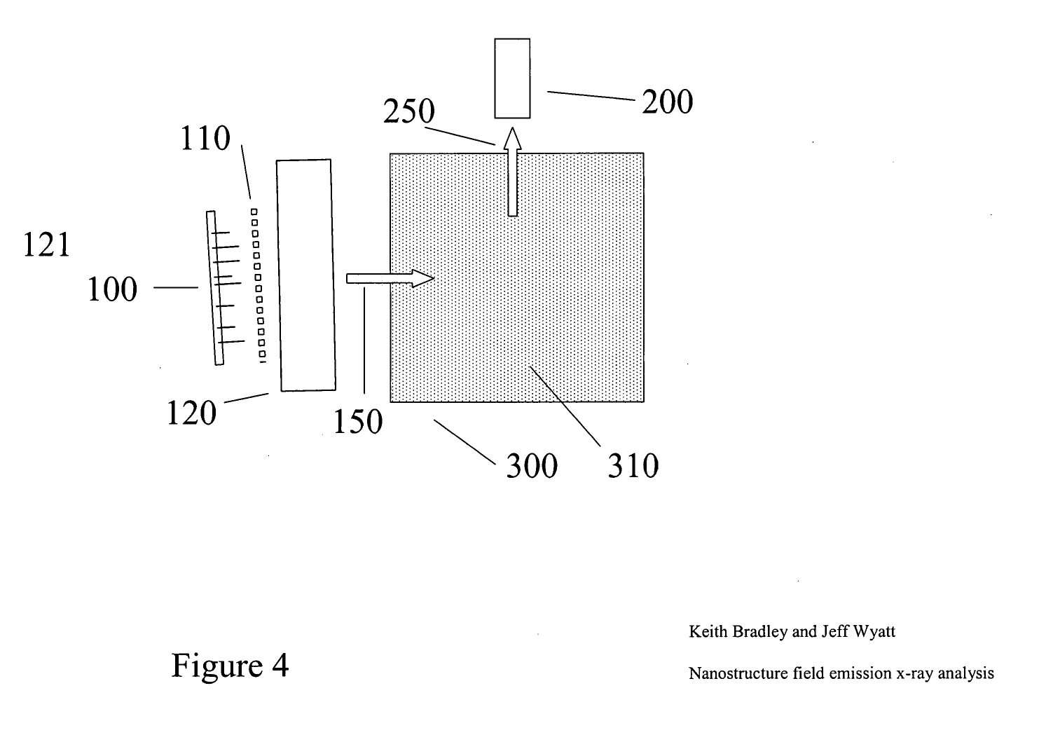

FIG. 4: Schematic of a device for measuring the density of fluids.
4-100: A nanostructure anode from which electrons are emitted.
4-110: An accelerating grid.
4-120: A target, which absorbs electrons and emits x-rays.
4-150: The direction traveled by x-rays emitted by the target.
4-200: An x-ray detector.
4-250: The direction traveled by x-rays detected by the detector.
4-300: A chamber containing fluid.
4-310: Fluid for density analysis.

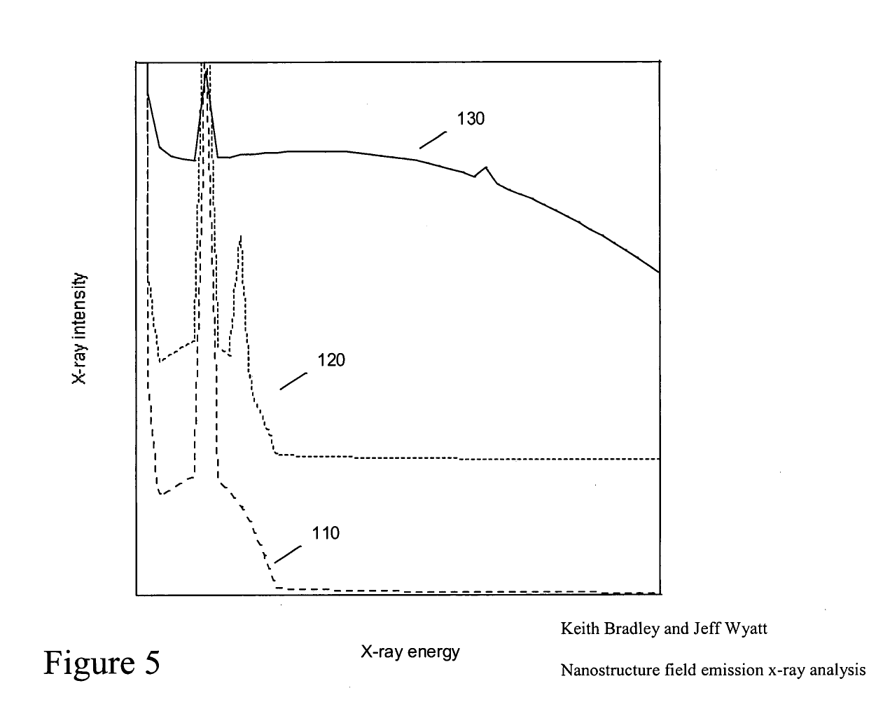

FIG. 5: Schematic x-ray fluorescence spectra that would be recorded from a piece of rock that consists of quartz with 1% gold mixed in.
5-110: With the rock irradiated by 2.05 kV x-rays.
5-120: With the rock irradiated by 2.20 kV x-rays.
5-130: With the rock irradiated by 10 kV x-rays.

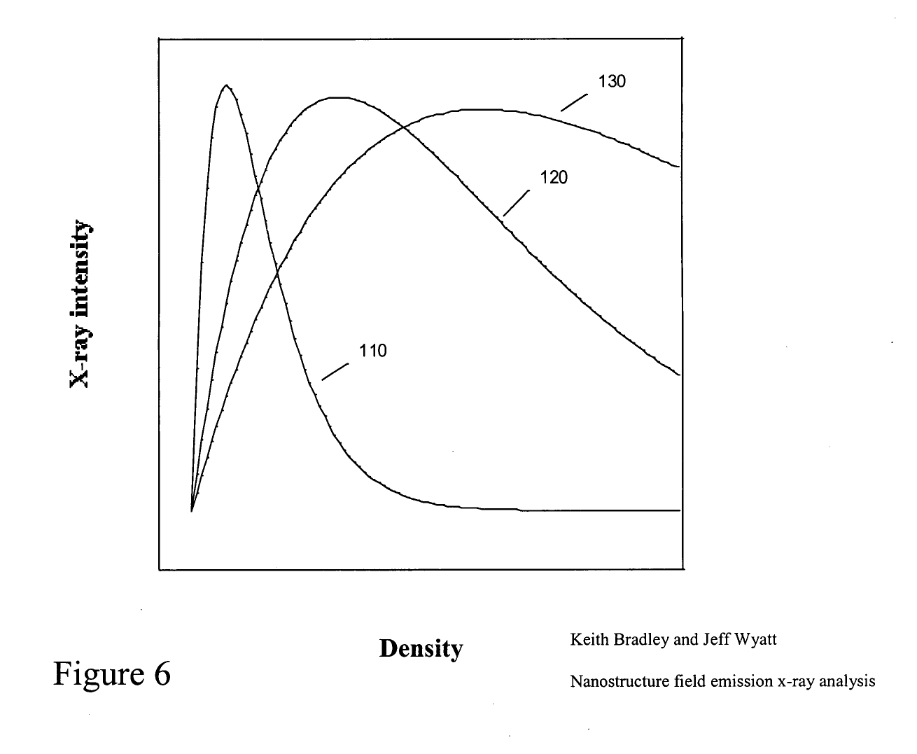

FIG. 6: The intensity of x-rays received by a detector at a fixed position is plotted on the y-axis, as a function of the density of carbon in a hydrocarbon fluid. Three curves are shown, corresponding to low, medium, and high energies of x-rays.
6-110: With low-energy x-rays.
6-120: With medium-energy x-rays.
6-130: With high-energy x-rays.

1. An x-ray spectrometer device comprising:
a field emission cathode, said cathode comprising a nanostructure-containing material;
an anode target;
an accelerating field established by a potential between the anode and the cathode;
at least one x-ray detector, said detector positioned such that x-rays from the target are substantially not received.

2. An x-ray spectrometer device as in claim 1,
wherein the nanostructure-containing material comprises carbon nanotubes.

3. An x-ray spectrometer device as in claim 3,
wherein the nanostructure-containing material further comprises a conductive binder.

4. An x-ray spectrometer device as in claim 1,
wherein the x-ray detector is an energy-dispersive x-ray detector.

5. An x-ray spectrometry device as in claim 1
further comprising a second field emission cathode.

6. An x-ray spectrometry device as in claim 5,
further comprising a second anode target.

7. An x-ray spectrometry device as in claim 1, further comprising:
a cable of at least 10 m length, said cable connected to as to supply electrical power to the detector.

8. An x-ray spectrometry device as in claim 1, further comprising:
a sample, said sample positioned so that the x-ray detector can receive x-rays from the sample.

9. An x-ray spectrometry system as in claim 8,
wherein the x-ray detector is an energy-dispersive detector.

10. An x-ray spectrometry system as in claim 8,
wherein the sample is a liquid.

11. An x-ray spectrometry device as in claim 8,
wherein the potential is at least 3 kV.

12. An x-ray spectrometry device as in claim 8,
wherein the anode target is selected from the group of iron, copper, and manganese.

13. An x-ray spectrometry device as in claim 8,
wherein the x-ray detector is less than than 3 inches in size.

14. A method of analyzing a sample, comprising:
irradiating the sample with x-rays of a first energy;
recording a first spectrum of x-rays emitted from the sample;
irradiating the sample with x-rays of a second energy;
recording a second spectrum of x-rays emitted from the sample.

15. A method of analyzing a sample as in claim 14,
wherein the first energy is less than 1.5 kV.

16. A method of analyzing a sample as in claim 14,
wherein the first energy is greater than 2.122 kV and the second energy is less than 2.122 kV.

17. A device for measuring the density of a fluid, comprising:
a field emission cathode, said cathode comprising a nanostructure-containing material;
an anode target;
an accelerating field established by a potential between the anode and the cathode;
at least one x-ray detector, said detector positioned such that x-rays from the target are substantially not received;
a chamber adjacent to the target;
a fluid, said fluid contained within the chamber.
